(19) United States
(12) Patent Application Publication
(10) Pub. No.: US 2024/0025701 A1
(43) Pub. Date: Jan. 25, 2024

(54) MOBILE DEVICE, GUARD UNIT, AND METHOD FOR ENSURING THE PERFORMANCE OF A SAFETY ACTIVITY FOR AN ELEVATOR

(71) Applicant: Inventio AG, Hergiswil (CH)

(72) Inventor: Ronny Kolb, Udligenswil (CH)

(21) Appl. No.: 18/254,388

(22) PCT Filed: Nov. 29, 2021
(86) PCT No.: PCT/EP2021/083291

§ 371 Date: May 25, 2023

(30) Foreign Application Priority Data
Dec. 2, 2020 (EP) 20211282.7

(51) Int. Cl. B66B 5/00; B66B 1/34

(52) U.S. Cl. CPC B66B 5/0087; B66B 5/0031; B66B 5/0025; B66B 1/3461

(57) ABSTRACT

A mobile device and a guard unit are utilized to ensure the performance of a safety activity needed to be executed before starting and/or ending an operation of an elevator. Furthermore, according to a method to be performed by such a mobile device and a guard unit, the mobile device or the guard unit provides a request to perform the safety activity for a user of the mobile device via a human-machine interface, and the mobile device sends a permission message to the elevator to permit the starting or ending of the operation of the elevator in response to an answer provided by the user to the request via the human-machine interface.

### FIELD

The present invention relates particularly to a mobile device and a guard unit for ensuring the performance of a safety activity needed to be executed before starting and/or ending an operation of an elevator. Furthermore, the invention relates to a method to be performed by such a mobile device and a guard unit.

### BACKGROUND

As elevators are applied for transporting passengers along vertical distances, strict safety requirements have to be fulfilled. Elevator maintenance is performed by elevator service personnel to keep elevator systems running safely. It is a systematic process of inspection which includes finding, diagnosing, and fixing problems before they cause machine breakdown, malfunction, or shutdown. Concerning this, a set of elevator technical features has to be checked by service personnel regularly and especially before beginning with maintenance or inspection work, because technicians must often go up on the roof of an elevator car or down to the pit in an elevator shaft during maintenance work so that it is potentially hazardous and could easily cause accidents and even fatalities to these technicians. Therefore, necessary safety precautions should be executed before carrying out an elevator maintenance task.

A competent technician who is responsible for carrying out maintenance service should pay particular attention to carry out a special safety precaution. Therefore, he must thoroughly familiarize himself with the content of the service manual and finish some risk assessments at his workplace in advance, for example, devising safety measures or implementing an emergency preparedness (e.g. rescue procedures and arrangements for evacuations). Generally, the technician should undertake a checklist or finish some safety procedure steps before beginning or after completing maintenance or inspection of an elevator. Sometimes, the technician may perform a so-called elevator audit for helping to determine e.g. the condition of an elevator. This to say that some elevator components or units are to be tested or at least checked before to be used. If a technician is going to carry out maintenance inside an elevator car, he shall check the condition of signs and operating device symbols, button functions, ventilation, lighting, car door force when opening and closing. Furthermore, the technician has to test and check the effectiveness and functions of emergency devices (e.g. various stopping devices like emergency stop, starting/stopping devices, and safety switches) before starting work to prove whether such devices are available and in good working conditions. The technician should also check the reliance upon the network like the Internet for carrying different kinds of communications both within a local network and with the outside world (public, remote sites, business partners, etc.).

However, the problem may be that it is often not clear whether the technician has followed certain safety procedures to comply with his duty indeed. It has been observed that, on the one hand, such a safety procedure can be ignored because the technician maybe finds it troublesome or not necessary. On the other hand, the safety procedures could be very complex and very different for each elevator so that the technicians cannot always know exactly what they have to do, even if they are sufficiently qualified. Currently, there is no traceability or automatically recorded evidence that service technicians have followed the procedures to ensure their own and other people's safety. For example, at turning on an installation travel mode of an elevator, it is expected that service personnel shall follow certain safety procedure steps. Even though a control system of an elevator currently is not able to ensure whether a requested safety procedure has been followed, the control system will just enable an installation travel mode that could perhaps lead to a severe danger to service personnel. And this may also make a post-event analysis and investigation of an accident difficult.

### SUMMARY

Accordingly, there may exist a need for enhancing safety during installation or maintenance work of an elevator, while such efforts and costs of personnel training or complicated processing costs for monitoring complying with a safety regulation can be reduced. Such needs may be met with the subject-matter of the advantageous embodiments defined in the following specification.

According to the first aspect of the invention, a mobile device is proposed for ensuring the performance of a safety activity that needs to be executed before starting and/or ending an operation of an elevator. The mobile device is e.g. a portable device like a smart mobile phone or a portable computer, etc. The mobile device is equipped with a questioning unit comprising or being capable of communicating with a user interface (UI) or a human-machine interface (HMI) for providing a request to perform the safety activity for a user of this mobile device. This means that the HMI may be a part of the questioning unit or may be provided as a separate device of the elevator or even any other device.

The request can relate to just a simple activity e.g. to confirm where the technician is located when he is going to start such operation of the elevator. For example, the request requires that the technician should stay outside the hoistway of the elevator. In order to communicate to the elevator that this technician is now in a safe place, he needs only to use his smartphone to scan a code (e.g. QR-code, 3D-code, Barcode) generated by a landing operation panel (LOP) or a car operation panel (COP) of an elevator. In this way, it is determined that the technician at the moment of scanning the code is outside of the hoistway or inside the car of the elevator. Once the code has been scanned, the smartphone communicates with and communicates to the elevator that the technician is now in a safe place. By scanning the code displayed on the LOP/COP, the request of the safety activity for starting the intended operation of the elevator can be considered as fulfilled. The request may also comprise more questions or be created as a checklist involving at least one question relating to at least one step of a safety procedure, wherein via the HMI the questioning unit is capable of asking questions to and receiving feedback from a user of the mobile device. In this way, the implementation of the checklist can be confirmed at least by the user himself. Service personnel as users of such mobile devices may use this opportunity to check or correct critical problems that they may encounter during maintaining elevators. Furthermore, the mobile device comprises a processor and a communication unit, wherein the processor can send a permission message via the communication unit to the elevator to permit the starting or ending of the operation of the elevator in response to an answer provided by the user to the request via the HMI. The communication unit and the processor may be built as separate units or may be integrated into the questioning unit.

The HMI is preferably configurated as a graphical user interface (GUI). Alternatively or additionally, the questioning unit may also comprise a speaker-microphone arrangement. For instance, the HMI may be integrated into a LOP or a COP of the elevator. Particularly, the HMI can be formed by the mobile device which may then interact with the questioning unit such as to exchange any information between the user and the questioning unit.

Rather than relying on training, written procedures, and other manual and thus not so efficient and reliable approaches, the idea is to control the adherence to safety procedures by mobile devices e.g. via a mobile App (application software). When a technician e.g. wants to turn on IMOF (Information installation Travel) of an elevator, nothing will happen at first, since a set of specific questions/instructions has not been answered or followed yet. For example, an App of the smartphone may be automatically or manually activated by the technician who will be prompted by the App to follow certain process steps to finish required safety activities. By reminding the technician of paying attention to certain advisable or required safety procedures, by providing help information, and by requiring confirmation from the technician, the personal safety during maintenance work may be enhanced. It may also help to trace the execution of such safety procedures e.g. in an accident analysis afterward.

According to an embodiment, the communication unit is capable of communicating with the elevator for detecting the starting and/or ending of the operation of the elevator. The communication unit may detect either an intention of operating the elevator or switching of an operation of the elevator. For example, the communication unit can monitor a switch or sensor (e.g. shaft door contact) installed in the elevator or communicate with a controller of the elevator. The controller and the switch or sensor are configured for generating a monitoring signal based on a sensed current operating state of the elevator. Another possibility could be that the controller sends a message to the communication unit to inform it about a command received by the controller to start or terminate the operation of the elevator. On the other hand, the communication unit may also communicate with other databases or networks, e.g. a public network. During performing predefined safety activities, a service center of the elevator may help service personnel to overcome occurred technical problems.

According to an embodiment, the processor of the mobile device is able to check whether the answer is correct and/or evaluate the answer of the user concerning a length of time required to perform the safety activity, while the questioning unit of the mobile device may require a confirmation via the HMI when the answer is received earlier than a predetermined time. In other words, the mobile device won't permit to start or terminate the requested operation of the elevator if the consulted user has not responded to the request or has taken far less time than a reasonable or anticipated length of time. The reasonable length of time may concern a time period between a predetermined minimum time and a predetermined maximum time. Moreover, the questioning unit may require a confirmation via the HMI if the answer is received earlier than the predetermined minimum time needed to finish the safety activity, as the mobile device assumes that the technician should have not fulfilled at least a part of his duties. This minimum time is calculated according to the average time required e.g. by experienced technicians to do the same safety activity. If the questioning unit would have not received any answer or confirmation within the predetermined maximum time, the questioning unit can generate an alarm signal for reminding the technician of this unanswered request or confirmation. Otherwise, if the answer is received within a reasonable time period, the mobile device will default recognize that the user has completed all safety activities as required. Upon such reactions of the mobile device, the user can be alerted again or warned to pay attention to safety requirements. Thereby, it may be avoided that e.g. only a simple answer to a question asked by the questioning unit may allow the mobile device to send a permission message to the elevator because this answer could be caused by an unintentional operating of the user. The risk of an unanticipated operation of the elevator promoted by an inadvertently or intendedly wrong answer of technicians thus may be reduced.

According to another embodiment, the mobile device comprises or is capable of communicating with a memory unit for saving the answer to the request and/or the confirmation with a timestamp and/or an identity of the user. This means that the answer or the confirmation may comprise a timestamp-based identifier of the user. A timestamp is a sequence of characters or encoded information for identifying the time when the answer or the confirmation is received by the mobile device. To help users of the mobile device, information about how to undertake a safety activity may be stored in the memory unit and can be accessed e.g. by the mobile device upon the identity of its user.

According to the second aspect of the invention, a guard unit is provided for ensuring a safety activity which needs to be executed before starting and/or ending the operation of an elevator, wherein the guard unit can be installed at the elevator for suspending a starting and/or ending of the operation of the elevator. The guard unit can communicate with a mobile device in such a manner that the guard unit may release the suspended operation of the elevator after receiving a permission message from the mobile device. In this case, the guard unit regards the permission message as a confirmation that the safety activity has been executed completely.

According to an embodiment, the guard unit may send a request to the mobile device for performing a safety activity. This request can be sent independently on receiving the permitting message. The to be executed safety activity can be either the same activity expected to be taken for starting or ending the operation of the elevator or an additional auxiliary safety activity. Particularly, the guard unit may request the user of the mobile device to carry out a checklist about safety activities. Alternatively, such a checklist may be sent from the guard unit to the mobile device if the mobile device does not create the checklist.

According to an embodiment, the guard unit may check whether the answer is correct and/or evaluate the permission message concerning a certain length of time that is required to perform the safety activity. This length of time has taken a reasonable time for completing all required safety activities into account. The guard unit may require a confirmation of the mobile device when the permission message is received earlier than the predetermined minimum time. Furthermore, the guard unit can generate an alarm signal in case of no answer or confirmation being received within the predetermined maximum time. Generally, since the proposed guard unit requires active interaction of the user of the mobile device to answer the request, namely executing the safety activity to meet his duty, the guard unit may recognize whether the consulted user has completed the interaction or has just intendedly given a wrong answer but without having fulfilled his duty.

Similar to the mobile device, the guard unit may comprise or be capable of communicating with a memory unit for saving the permission message and/or confirmation with a timestamp and/or an identity of the mobile device. The memory unit may be a unit of the guard unit or the elevator. Alternatively, the memory unit may be also a separate memory unit like a USB or SD-card. For instance, the content of the request for performing the safety activity may be predetermined and saved in the memory unit. A completed report generated by the mobile device or the guard unit about executing the required safety activities may also be saved in this memory unit.

According to the third aspect of the invention, a method is proposed to ensure and monitor the performance of a safety activity that needs to be executed before starting and/or ending the operation of an elevator. The method comprises the following steps,
building up communication between the elevator and a mobile device comprising or communicating with a human-machine interface,
providing a request to perform the safety activity for a user of the mobile device via the human-machine interface, sending a permission message from the mobile device to the elevator to permit the starting or ending of the operation of the elevator in response to an answer provided by the user to the request via the human-machine interface.

Such a method by using the mobile device and guard unit then will be implemented as a helpful reminder or assistance for service personnel to prepare maintenance work. In addition, the permission message sent from the mobile device may indicate with a sufficiently high probability as a confirmation that the required safety activities should have been accomplished completely.

The execution of the required safety activity is in a manner equivalent to a check-in or check-out process guided via a mobile app of a smartphone.

According to the fourth aspect of the invention, an elevator system may comprise an afore-mentioned guard unit and/or be capable to communicate with an afore-mentioned mobile device. or may execute a method introduced before to ensure and monitor the performance of a safety activity that needs to be executed before starting and/or ending the operation of an elevator.

It shall be noted that possible features and advantages of embodiments of the invention are described herein partly with respect to an electronic elevator guard unit, partly with respect to an electronic elevator guard method to be performed preferably by such device, and partly with respect to an elevator comprising such electronic elevator guard unit. One skilled in the art will recognize that the features may be suitably transferred from one embodiment to another and features may be modified, adapted, combined and/or replaced, etc. in order to come to further embodiments of the invention. Ideas underlying embodiments of the present invention may be interpreted as being based, inter alia, and without restricting the scope of the invention, on the following observations and recognitions.

In the following, advantageous embodiments of the invention will be described regarding the enclosed drawings. However, neither the drawings nor the description shall be interpreted as limiting the invention.

### DESCRIPTION OF THE DRAWINGS

FIG. 1 shows an elevator with a mobile device and a guard unit according to an embodiment of the present invention;

FIG. 2 shows the mobile device according to the present invention;

FIG. 3 shows a flow diagram of a method according to an embodiment of the present invention;

FIG. 4 shows a flow diagram of a method according to another embodiment of the present invention; and

FIG. 5 shows a flow diagram of a method according to a further embodiment of the present invention.

For the purpose of illustration, the following description sets forth details regarding a mobile device and a guard unit of an elevator or a method that could be performed using the technology of the invention. The figures are only schematic and not to scale. The same reference signs refer to the same or similar features.

### DETAILED DESCRIPTION

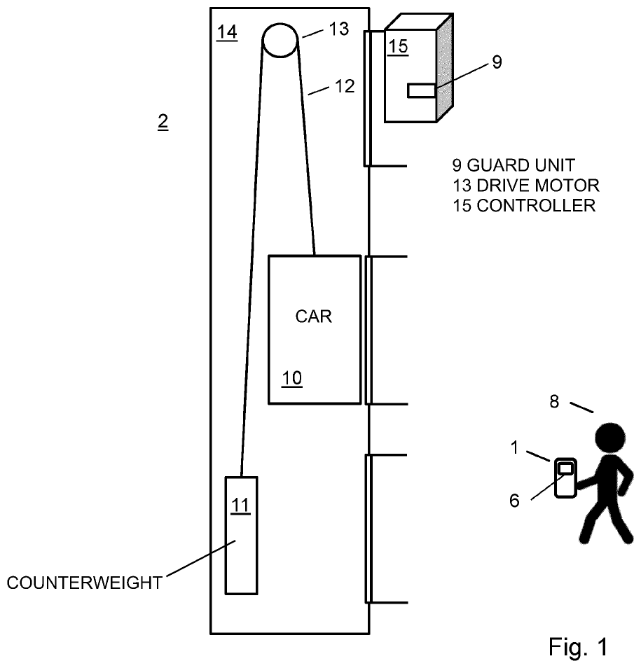

FIG. 1 shows an elevator 2, a mobile device 1, and a guard unit 9. This elevator 2 comprises an elevator car 10 and a counterweight 11 suspended by several suspension traction members 12 like ropes or belts. The suspension traction members 12 may be driven by a drive motor 13 to displace the car 10 and the counterweight 11 within an elevator shaft 14.

The mobile device 1 is e.g. a smartphone and assigned to a technician 8 who will start or end an operation of the elevator 2. A specific App is installed on the mobile device 1 for suitable communication with a controller 15 of the elevator 2. If the technician 8 is going to maintain the elevator 2, he should at first accomplish certain safety activities before the maintenance work begins. The purpose of such safety activities is to protect the technician 8 or other persons during the maintenance work for the elevator 2.

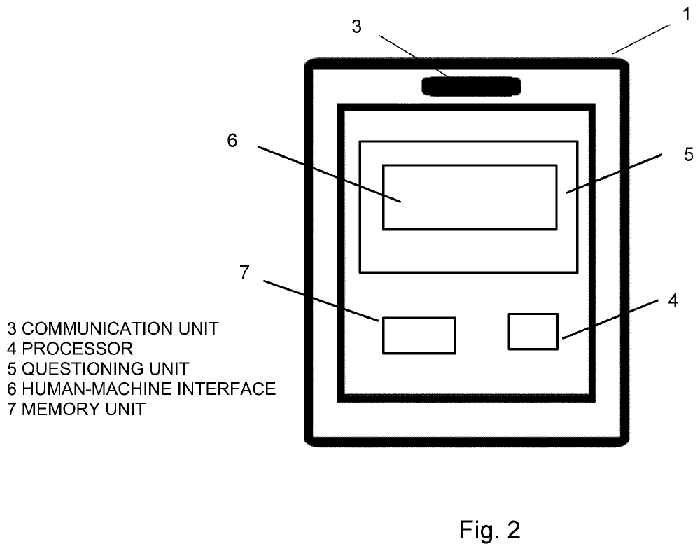

As shown in FIG. 2, the mobile device 1 comprises a questioning unit 5 which is configured for asking predetermined questions to the technician 8, namely the user of the mobile device 1. The questioning unit 5 may comprise or communicate with a human-machine interface (HMI) 6 for providing a request to perform the safety activity. For this embodiment, the HMI 6 is a part of the questioning unit 5. The request may consist of at least one predetermined question. The questioning unit 5 can ask the technician 8 by issuing a question and expects the technician inputting his answer to this question.

The HMI 6 is e.g. a touchscreen configured for displaying the questions and receiving the answers via manual touch-input. For example, such an HMI 6 may be realized by the display of the mobile device 1 that may interact with the questioning unit 5 and with the technician 8 for exchanging information between them. For example, on the display, the request is displayed for the user 8 of the mobile device 1. Preferably, the questions of the request may be formulated, such as they may be answered simply by “Yes” or “No”. The HMI 6 could be also a voice or language user interface. If questions are outputted by a loudspeaker of the mobile device 1 as spoken language, the technician 8 may give his answer also in spoken language through a microphone of the HMI 6.

The request for performing safety activities is configured e.g. in form of a checklist involving more questions relating to what the technician 8 should have finished before he operates the elevator 2. Furthermore, the mobile device 1 comprises a processor 4 and a communication unit 3 which may be built as separate units or may be integrated into the questioning unit 5. In this embodiment according to FIG. 2, the communication unit 3 is a separate unit. The communication unit 3 monitors a switch or sensor of the elevator 2, wherein the state of the switch or the signal generated by the sensor may indicate an operating activity or a current state of the elevator 2. The processor 4 will send a permission message via the communication unit 3 to the elevator 2 to permit the starting or ending of the operation of the elevator 2 when the technician 8 has answered the request via the HMI 6. Additionally, the processor 4 can check the correctness of the answer and/or evaluate the answer provided by the technician 8 in relation to the length of time which he needs to finish the requested safety activity. If the technician 8 would not send his answer within a reasonable time, the questioning unit 5 may require a confirmation from the technician 8. Thereby, it can be avoided that just a single answer provided by the technician 8 to the request may allow the mobile device 1 to send a permission message to the elevator 2, because this answer might be caused by an unintentional input by the technician 8. The risk of an unanticipated operating of the elevator 2 promoted by an inadvertently or intendedly wrong answer thus can be reduced. Otherwise, if the answer is received within a reasonable time, the mobile device 1 will default that the technician 8 has completed the requested safety activity. Sometimes, the questioning unit 5 will not receive an answer or a confirmation from the technician 8 within a predetermined maximum time. In reaction thereto, the questioning unit 5 will generate e.g. an acoustic alarm signal.

Corresponding to the mobile device 1, a guard unit 9 shown in FIG. 1 is provided which can be installed at the elevator 2 for temporarily suspending or blocking the starting and/or ending of the operation of the elevator 2. The guard unit 9 may communicate with a mobile device 1 in such a manner that the guard unit 9 can release the suspended operation of the elevator 2 after receiving a permission message from the mobile device 1, as the guard unit 9 regards the permission message in this case as a confirmation that the safety activity has been executed completely.

The guard unit 9 may send a request to perform a safety activity that needs to be executed to the mobile device 1 of the HMI 6, e.g. before receiving or accepting the permission message. This to be executed safety activity could be the same activity required by the mobile device 1 or another different activity. The guard unit 9 can e.g. evaluate the permission message in relation to a certain reasonable length of time required to complete the whole safety activity. The reasonable length of time concerns e.g. a time period between a predetermined minimum time and a predetermined maximum time. The guard unit 9 will require a confirmation from the mobile device 1 if the permission message is received earlier than the predetermined minimum time. Moreover, the guard unit 9 may also generate an alarm signal in the case of no answer or confirmation being received within the predetermined maximum time.

The mobile device 1 or the guard unit 9 may comprise e.g. a memory unit 7 for saving the answer and the confirmation provided by the technician 8 e.g. with a timestamp and/or an identity of the technician 8. Help information about how to carry out required safety activities may be also stored in such a memory unit 7 and be accessible to technicians 8 according to their identities. The help information may be detailed instructions in form of text, graphics, or videos that are specific to the type of elevator and its control system. For example, if the technician 8 is asked by the HMI 6, the technician 8 needs to identify himself at first by entering an authorization code. Various other ways of identifying or authenticating users 8 of mobile devices 1 like by identity card, fingerprint recognition, face recognition, voice recognition, etc. are also possible. After being identified, the technician may call the stored help information. Furthermore, a completed report may be generated by the mobile device 1 or the guard unit 9 about the execution of the required safety activities and may be saved in this memory unit 7.

Using this mobile device 1 and the guard unit 9 may improve the safety of a technician 8 if he is going to start or terminate a certain service work.

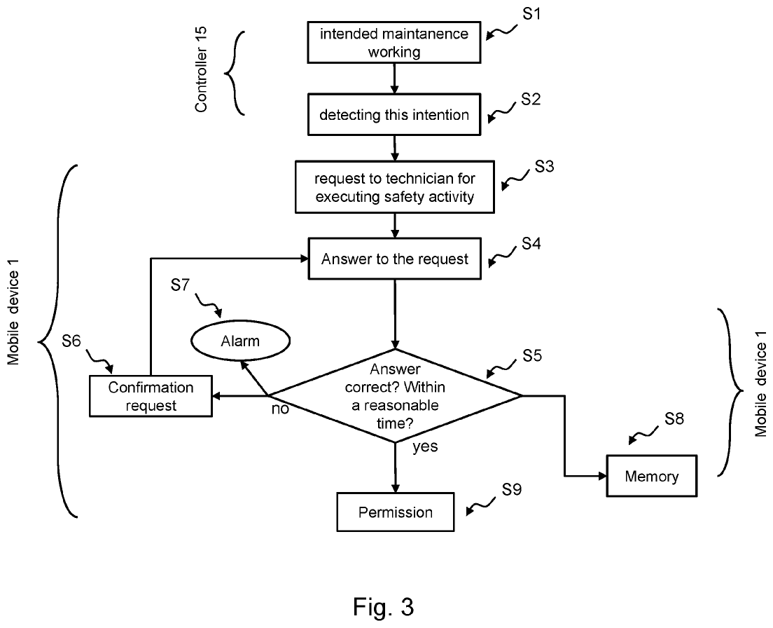

FIG. 3 to FIG. 5 show respectively a method for ensuring the performance of a safety activity that needs to be executed before starting and/or ending the operation of an elevator 2. The operation of the elevator 2 cannot be started or ended until the elevator 2 receives the permission message from the mobile device 1.

Particularly, FIG. 3 shows the following steps of this method:
S1: A technician 8 intends to begin maintenance work for an elevator 2 by e.g. opening a control cabinet or a shaft door of the elevator 2;
S2: A controller 15 of the elevator 2 sends a message to a mobile device 1 of the technician 8 to indicate that a door contact of the control cabinet or the shaft door now is open. This means the intention of the technician has been detected by the elevator 2;
S3: The mobile device 1 will recognize that maintenance or an inspection work will be executed soon so that the mobile device 1 sends a request via an HMI 6 to the technician 8 to require him to perform a safety activity, e.g. to go through a checklist;
S4: After completing the checklist, the technician 8 gives his answer to the request via the HMI 6;
S5: The mobile device 1 receives the answer and will check whether this answer is correct (e.g. all the questions of the checklist have been answered correctly) and/or evaluate it according to a reasonable length of time in which the required safety activity may be carried out completely. The reasonable length of time concerns e.g. a time period between a predetermined minimum time and a predetermined maximum time;
S6: If the answer is provided earlier than the predetermined minimum time has expired, the mobile device 1 will require a confirmation from the technician 8. The confirmation will be regarded as an answer to the request;
S7: Optionally, the mobile device 1 may generate an alarm signal in the case of no answer or no confirmation has been received from the technician 8 within the predetermined maximum time;
S8: The answer and/or the confirmation provided by the technician 8 and the evaluation of the answer and/or the confirmation will be saved in a memory unit 7 of the mobile device 1;
S9: When the mobile device 1 accepts the answer or confirmation provided by the technician 8, the mobile device 1 will send a permission message to the elevator 2 that a maintenance operating mode of the elevator 2 can be started.

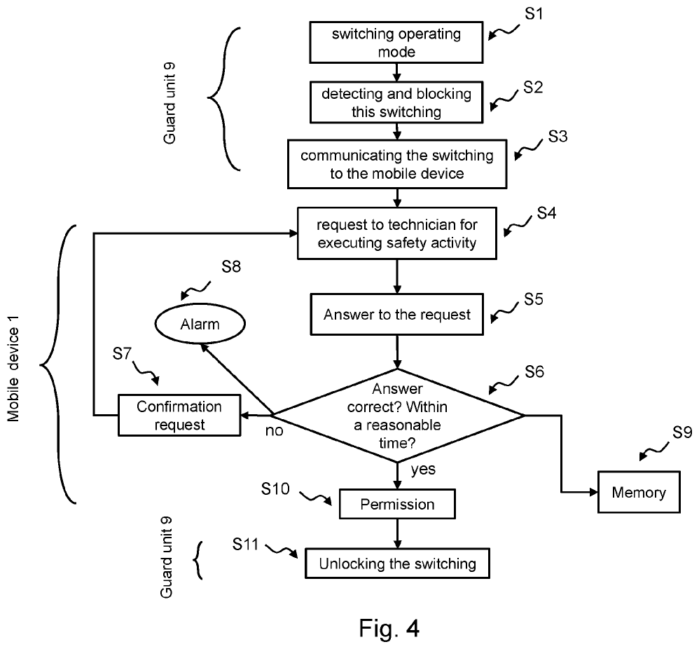

A similar process is shown in FIG. 4, wherein a technician 8 is going to begin inspection work for an elevator 2.
S1: The technician 8 enters in the hoistway of the elevator 2 and switches it into its inspection operating mode;
S2: A guard unit 9 of the elevator 2 may detect this switching of the elevator 2 and postpones or blocks temporarily the starting of the inspection operating mode;
S3: The guard unit 9 communicates the switching of the elevator 2 into its inspection operating mode to the mobile device 1;
S4: The mobile device 1 generates and sends a request via an HMI 6 to the technician 8 to require him to perform a safety activity;
S5: The technician 8 performs the safety activity and gives his answer to this request via HMI 6 to communicate to the mobile device 1 that he has completed the required safety activity;
S6: The mobile device 1 checks the correctness of the answer and/or evaluates the answer according to a reasonable length of time in which the safety activity may be completed entirely. The reasonable length of time concerns e.g. a time period between a predetermined minimum time and a predetermined maximum time;
S7: If the technician 8 gives the answer before the predetermined minimum time has expired, the mobile device 1 will require a confirmation from the technician 8. The confirmation will be regarded as an answer to the request;
S8: Optionally, the mobile device 1 generates an alarm signal, if no answer or no confirmation has been received from the technician 8 within the predetermined maximum time;
S9: The answer and/or the confirmation provided by the technician 8 and the evaluation of the answer and/or the conformation will be sent to and saved in a memory unit 7 of the elevator 2;
S10: By accepting this answer or confirmation, the mobile device 1 may send a permission message to the guard unit 9;
S11: The guard unit 9 then unlocks the switching, namely releases the postponed/blocked switching of the elevator 2 into its inspection operating mode, and permits the technician 8 to start the maintenance operating mode of the elevator 2.

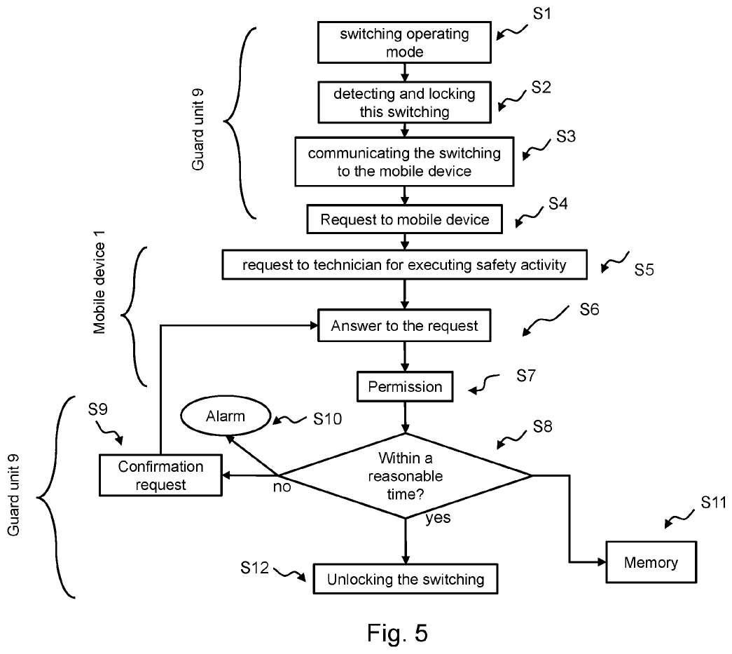

FIG. 5 shows an alternative to the embodiment of FIG. 4.

In this alternative embodiment, steps S1 to S3 are the same steps as in the embodiment of FIG. 4, and it comprises:
S4: The guard unit 9 sends a request to perform a certain safety activity to the mobile device 1 via the HMI 6;
S5: According to this request, the mobile device 1 requires the technician 8 to execute the requested safety activity;
S6: The technician 8 executes the safety activity and gives his answer to this request via the HMI 6 to inform the mobile device 1 that he has completed entirely the required safety activity;
S7: The technician 8 sends a permission message from the mobile device 1 to the guard unit 9;
S8: The guard unit 9 will evaluate this permission message according to a reasonable length of time in which the required safety activity may be completely executed. The reasonable length of time concerns e.g. a time period between a predetermined minimum time and a predetermined maximum time;
S9: If the technician's permission message is given before the predetermined minimum time expires, the guard unit 9 requires a confirmation from the technician 8 via the mobile device 1;
S10: Optionally, the guard unit 9 may generate an alarm signal in the case of no permission message or no confirmation has been received from the technician 8 within the predetermined maximum time;
S11: The answer or the confirmation provided by the technician 8 and their evaluation will be sent to and saved in a memory unit 7 of the guard unit 9;
S12: If the guard unit 1 accepts the permission message or confirmation provided by the technician 8, the guard unit 9 will permit the technician 8 to start the maintenance operating mode of the elevator 2. This means that the guard unit 9 will unlock the switching of the elevator 2, namely release the postponed/blocked switching of the elevator 2 into its inspection operating mode.

Based on one of the embodiments introduced in FIG. 2 to FIG. 5 a simple or comprehensive report about the execution of the safety activity may be generated by the mobile device 1 or the guard unit 9. This report will be e.g. stored in the memory unit 7 or a cloud and can be shared and accessed within the organization of the technician 8. Upon such a report, the employer of the service personnel may motivate a technician 8 to carry out the requested safety activity by providing a specific type of reward. On the other hand, the consulted technician 8 may also be penalized in case he has not given his answer or confirmation to the request.

Finally, it should be noted that the term “comprising” does not exclude other elements or steps, and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1.-15. (canceled)

16. A mobile device for ensuring a performance of a safety activity needed to be executed before starting and/or ending an operation of an elevator, the mobile device comprising:
a questioning unit including or communicating with a human-machine interface, the questioning unit providing a request to perform the safety activity for a user of the mobile device; and
a processor and a communication unit, wherein the processor is adapted to send a permission message via the communication unit to the elevator to permit the starting or the ending of the operation of the elevator in response to an answer provided by the user to the request via the human-machine interface, wherein the processor at least one of checks a correctness of the answer and evaluates the answer concerning a length of time required to perform the safety activity.

17. The mobile device according to claim 16 wherein the communication unit communicates with the elevator to detect the starting and/or the ending of the operation of the elevator.

18. The mobile device according to claim 16 wherein the questioning unit requires a confirmation via the human-machine interface when the answer is received earlier than a predetermined minimum time and/or wherein the questioning unit generates an alarm signal when no answer or no confirmation is received within a predetermined maximum time.

19. The mobile device according to claim 18 being adapted to communicate with a memory unit to save the answer to the request and/or the confirmation with a timestamp and/or an identity of the user.

20. The mobile device according to claim 19 wherein the request to perform the safety activity is predetermined depending on the operation to be started and/or ended and is saved in the memory unit.

21. A guard unit for ensuring starting and/or ending an operation of an elevator, the guard unit comprising:
the guard unit adapted to be installed at the elevator for suspending starting and/or ending of the operation of the elevator;
the guard unit communicating with a mobile device such that the guard unit releases a suspended operation of the elevator after receiving a permission message from the mobile device;
wherein the guard unit regards the permission message as a confirmation that a safety activity has been executed; and
wherein the guard unit evaluates the permission message concerning a length of time required to perform the safety activity.

22. The guard unit according to claim 21 being adapted to send a request to perform the safety activity to the mobile device.

23. The guard unit according to claim 22 wherein the guard unit requires a confirmation from the mobile device when the permission message is received earlier than a predetermined minimum time, and/or the guard unit generates an alarm signal when an answer to the request or the confirmation is not received within a predetermined maximum time.

24. The guard unit according to claim 22 wherein the guard unit communicates with a memory unit to save the permission message and/or the confirmation with a timestamp and/or an identity of the mobile device, and/or predetermines the request depending on the operation of the elevator and saves the request in the memory unit.

25. A method to ensuring a performance of a safety activity needed to be executed before starting and/or ending an operation of an elevator, the method comprising the steps of:
establishing a communication between the elevator and a mobile device, the mobile device including or communicating with a human-machine interface;
providing a request to perform the safety activity for a user of the mobile device via the human-machine interface;
sending a permission message from the mobile device to the elevator to permit the starting or ending of the operation of the elevator in response to an answer provided by the user to the request via the human-machine interface; and
evaluating the permission message concerning a length of time required to perform the safety activity.

26. The method according to claim 25 wherein the mobile device detects the starting and/or ending of the operation of the elevator.

27. The method according to claim 25 wherein the elevator blocks the starting and/or ending of the operation of the elevator until receiving the permission message.

28. The method according to claim 25 including requiring a confirmation from the mobile device when the permission message is received earlier than a predetermined minimum time, and/or generating an alarm signal when the answer or the confirmation is not received by the elevator within a predetermined maximum time.

29. The method according to claim 28 including saving the permission message and/or the confirmation with a timestamp and/or an identity of the mobile device.

30. An elevator system comprising:
a controller; and
a mobile device communicating with the controller to perform the method according to claim 25.

31. An elevator system comprising:
a guard unit; and
a mobile device communicating with the guard unit to perform the method according to claim 25.
